(19) United States
(12) Patent Application Publication
(10) Pub. No.: US 2026/0042126 A1
(43) Pub. Date: Feb. 12, 2026

(54) METHOD FOR CLEANING SAMPLING PIPELINE OF SAMPLE PROCESSOR, PIPELINE SYSTEM FOR IMPLEMENTING THE METHOD, AND SAMPLE PROCESSOR

(71) Applicant: Beckman Coulter Biotechnology (Suzhou) Co., Ltd., Suzhou, Jiangsu (CN)

(72) Inventors: Linqun TANG, Suzhou, Jiangsu (CN); Xin JIN, Suzhou, Jiangsu (CN); Yi GUO, Suzhou, Jiangsu (CN); Hao DING, Suzhou, Jiangsu (CN); Juntao YUAN, Suzhou (CN); Yanqiang REN, Suzhou, Jiangsu (CN)

(73) Assignee: Beckman Coulter Biotechnology (Suzhou) Co., Ltd., Suzhou, Jiangsu (CN)

(21) Appl. No.: 19/101,863

(22) PCT Filed: Jun. 7, 2024
(86) PCT No.: PCT/CN2024/097943

§ 371 Date: Feb. 6, 2025

(30) Foreign Application Priority Data
Jun. 9, 2023 (CN) 202310680802.0
Mar. 8, 2024 (CN) 202410265680.3

(51) Int. Cl. B08B 9/032; G01N 1/10

(52) U.S. Cl. CPC B08B 9/0325; B08B 2209/032; G01N 1/10

(57) ABSTRACT

The present disclosure relates to a method for cleaning a sampling pipeline of a sample processor, wherein the sampling pipeline communicates a flow cell to a sample source of the sample processor. The method comprises: a forward rinsing step of rinsing the sampling pipeline in a first direction by using a sheath liquid or a cleaning liquid different from the sheath liquid and provided via a cleaning liquid pipeline; and/or a reverse rinsing step of rinsing the sampling pipeline in a second direction opposite to the first direction by using the sheath liquid or the cleaning liquid. The present disclosure also provides a pipeline system for implementing the above method and a sample processor comprising the pipeline system. The method, pipeline system and sample processor according to the present disclosure have significantly improved cleaning effect.

### FIELD

The present disclosure relates to a sample processor such as a flow cytometry sorter/analyzer, a fluid pipeline system of the sample processor and a method for cleaning the pipeline system.

### BACKGROUND

This section only provide background information related to the present disclosure, which is not necessarily the prior art.

A sample processor is generally used to analyze a liquid sample including small suspended particles (e.g., biological particles, non-biological particles) or cells and/or to sort the particles or cells therein. During the operation of some known sample processors, the samples are transported to a flow cell by a pump for detection or sorting.

After the sample is analyzed or sorted, the sample (particularly, some particles in the sample) may be left in the pump and/or pipeline. Therefore, it is necessary to clean the pump and/or pipeline for processing the next sample. Beads, cells, viruses or extracellular vesicles and the like, especially nanoparticles, contained in the sample, are easily captured and gathered in the fluid pipeline of the sample processor, and are difficult to be cleaned.

### SUMMARY

This section provides a general summary of the present disclosure, rather than a comprehensive disclosure of the full scope of the present disclosure or all features of the present disclosure.

In the existing sample processor, the fluid pipeline is cleaned only through the sheath liquid or only in one direction. When the existing sample processor is used to clean nanoparticles, on the one hand, longer cleaning time is typically required, e.g., 30 minutes for viruses to reduce the virus residual rate to less than 1.0%, and 40 seconds for 3 micrometer breads to reduce the bread residual rate to less than 0.1%, so it consumes more cleaning fluid and negatively affects the flux of the instrument. On the other hand, it may be difficult to achieve the required residue rate (that is, cleaning requirements) for nanoparticles, for example, less than 0.1%, thereby affecting the detection accuracy of the instrument.

In addition, for the existing sample processor, it is necessary to manually replace the sample container or sampling pipeline with a container or cleaning pipeline that contains a cleaning liquid different from the sheath liquid, and then to clean the fluid pipeline with the cleaning liquid. Sometimes, it may be necessary to make multiple replacements between the sample container/sampling pipeline and the cleaning liquid container/cleaning pipeline. Therefore, the cleaning of the sample processor is time-consuming and inefficient, and may involve incorrect operations.

In view of the above problems of the existing sample processor, it is an object of the present disclosure to provide an improved pipeline system for a sample processor or an improved method for cleaning the sample processor that makes the cleaning process more effective or efficient.

According to an aspect of the present disclosure, a method for cleaning a sampling pipeline of a sample processor is provided, wherein the sampling pipeline communicates a flow cell to a sample source of the sample processor. The method includes: a forward rinsing step of rinsing the sampling pipeline in a first direction by using a sheath liquid or a cleaning liquid different from the sheath liquid and provided via a cleaning liquid pipeline; and/or a reverse rinsing step of rinsing the sampling pipeline in a second direction opposite to the first direction by using the sheath liquid or the cleaning liquid.

In some embodiments according to the present disclosure, the method includes: performing the forward rinsing step and the reverse rinsing step alternately for a predetermined number of times.

In some embodiments according to the present disclosure, the method includes: communicating the sheath liquid to a flow-cell opening and/or a sample opening of the sampling pipeline.

In some embodiments according to the present disclosure, a washing station is provided at the sample opening of the sampling pipeline, and the washing station has a sheath liquid port for supplying the sheath fluid and a discharge port for discharging waste liquid; and/or the flow cell has a sheath liquid port for supplying the sheath liquid and a discharge port for discharging waste liquid.

In some embodiments according to the present disclosure, the method includes: selectively using the sheath fluid or the cleaning liquid to clean the sampling pipeline by means of a switching device provided in the cleaning liquid pipeline and the sampling pipeline.

In some embodiments according to the present disclosure, the switching device is automatically controlled.

In some embodiments according to the present disclosure, the method includes: providing a peristaltic pump, and performing the forward rinsing step or the reverse rinsing step by controlling the rotation direction of a roller of the peristaltic pump.

In some embodiments according to the present disclosure, the method includes: providing a piston pump, and alternately performing the forward rinsing step and the reverse rinsing step through reciprocating motion of a piston of the piston pump.

According to another aspect of the present disclosure, a pipeline system for implementing the method described above is provided.

In some embodiments according to the present disclosure, the pipeline system includes a piston pump and a switching device provided in the sampling pipeline. The switching device is configured to selectively communicate the piston pump to the sample source or the flow cell. The piston pump is configured to alternately performing the forward rinsing step and the reverse rinsing step through reciprocating motion of a piston of the piston pump.

In some embodiments according to the present disclosure, the switching device is a rotary valve.

In some embodiments according to the present disclosure, the pipeline system includes a peristaltic pump that is configured to perform the forward rinsing step or the reverse rinsing step by controlling the rotation direction of a roller of the peristaltic pump.

In some embodiments according to the present disclosure, the pipeline system includes a switching device provided in the sampling pipeline and a cleaning liquid pipeline for supplying a cleaning liquid different from the sheath liquid. The switching device is configured to selectively supply a sample, sheath liquid or cleaning liquid.

In some embodiments according to the present disclosure, the switching device is a directional valve or an on-off valve.

In some embodiments according to the present disclosure, the switching device is a switching device which can be automatically controlled.

In some embodiments according to the present disclosure, a washing station is provided at a sample opening of the sampling pipeline, and the washing station has a sheath liquid port for supplying the sheath fluid and a discharge port for discharging waste liquid.

In some embodiments according to the present disclosure, the flow cell has a sheath liquid port for supplying the sheath liquid and a discharge port for discharging waste liquid.

According to yet another aspect of the present disclosure, a sample processor including the peristaltic pump pipeline system as described above is provided.

For the above pipeline system, method and sample processor according to the present disclosure, the cleaning efficiency and cleaning effect may be significantly improved, thereby the flux of the instrument is increased.

For some examples, the cleaning efficiency and cleaning effect may be significantly improved by the method of reciprocating cleaning.

For some examples, a piston pump is used to perform reciprocating cleaning, thereby further improving the cleaning efficiency and cleaning effect.

According to yet another aspect of the present disclosure, a peristaltic pump pipeline system for a sample processor is provided. The peristaltic pump pipeline system includes: a peristaltic pump; a sampling pipeline via which the peristaltic pump may pump a sample in a sample source to a flow cell of the sample processor; a cleaning liquid pipeline connecting a cleaning liquid source to the peristaltic pump; and a switching device configured to control interruption or communication of the cleaning liquid pipeline and interruption or communication of the sampling pipeline.

In some embodiments according to the present disclosure, the switching device is a directional valve, and the directional valve may be switched between a first position for allowing communication between the sample source and the flow cell, and a second position for allowing communication between the peristaltic pump and the cleaning liquid source.

In some embodiments according to the present disclosure, the directional valve is a three-way directional valve. The three-way directional valve has a first port connected to the peristaltic pump, a second port connected to the cleaning liquid source and a third port connected to the flow cell or the sample source, and the three-way directional valve may be switched between the first position where the first port and the third port are communicated, and the second position where the first port and the second port are communicated.

In some embodiments according to the present disclosure, the switching device includes a first on-off valve provided in the sampling pipeline, and a second on-off valve provided in the cleaning liquid pipeline.

In some embodiments according to the present disclosure, the switching device is a switching device that may be automatically controlled.

In some embodiments according to the present disclosure, the peristaltic pump pipeline system further includes a sheath pipeline connecting a sheath liquid source to the peristaltic pump, wherein the switching device is further configured to control interruption and communication of the sheath pipeline.

In some embodiments according to the present disclosure, the switching device is a four-way directional valve, having a first port connected to the peristaltic pump, a second port connected to the cleaning liquid source, a third port connected to the flow cell or the sample source, and a fourth port connected to the sheath source. The four-way directional valve may be switched between a first position where the first port and the third port are communicated, a second position where the first port and the second port are communicated, and a third position where the first port and the fourth port are communicated.

According to another aspect of the present disclosure, a method of cleaning a peristaltic pump of a sample processor is provided, wherein the peristaltic pump is configured to pump a sample in a sample source to a flow cell of the sample processor via a sampling pipeline. The method includes the following steps of: providing a cleaning liquid pipeline that connects a cleaning liquid source to the peristaltic pump; providing a switching device in the cleaning liquid pipeline; controlling, by the switching device, the sampling pipeline to be communicated and the cleaning liquid pipeline to be interrupted for sampling; and after the sample is processed, controlling, by the switching device, the sampling pipeline to be interrupted and the cleaning liquid pipeline to be communicated for cleaning the peristaltic pump with the cleaning liquid.

In some embodiments according to the present disclosure, the method further includes cleaning the peristaltic pump with a sheath liquid.

In some embodiments according to the present disclosure, the step of cleaning with the cleaning liquid and the step of cleaning with the sheath liquid are alternately switched and performed a predetermined number of times by the switching device.

In some embodiments according to the present disclosure, the sheath liquid is supplied from the flow cell to the peristaltic pump via the sampling pipeline.

In some embodiments according to the present disclosure, the peristaltic pump is rotated in a first direction for sampling. And, the peristaltic pump is rotated in a second direction opposite to the first direction for cleaning the peristaltic pump with the sheath liquid.

In some embodiments according to the present disclosure, the switching device is a three-way directional valve, having a first port connected to the peristaltic pump, a second port connected to the cleaning liquid source, and a third port connected to the flow cell or the sample source. The three-way directional valve may be switched between a first position where the first port is communicated with the second port, and a second position where the first port is communicated with the third port.

In some embodiments according to the present disclosure, the sheath liquid is supplied to the peristaltic pump via a sheath pipeline which connects the sheath source to the peristaltic pump.

In some embodiments according to the present disclosure, the switching device is a four-way directional valve, having a first port connected to the peristaltic pump, a second port connected to the cleaning liquid source, a third port connected to the flow cell or the sample source, and a fourth port connected to the sheath source. The four-way directional valve may be switched between a first position where the first port and the second port are communicated, a second position where the first port and the third port are communicated, and a third position where the first port and the fourth port are communicated.

In some embodiments according to the present disclosure, the switching device includes a first on-off valve provided in the sampling pipeline, and a second on-off valve provided in the cleaning liquid pipeline.

In some embodiments according to the present disclosure, the switching device is automatically controlled.

According to another aspect of the present disclosure, a sample processor including the peristaltic pump pipeline system as described above is provided.

With the peristaltic pump pipeline system, method and sample processor according to the present disclosure, by providing the cleaning liquid pipeline and controlling position of the switching device, the supply of the cleaning liquid can be easily controlled. It is not necessary to manually replace the sample source with a cleaning liquid source containing cleaning liquid, thereby reducing time required for the replacement, improving the efficiency of the sample processor, and avoiding wrong operation caused by manual replacement.

The switching device may be automatically controlled, thereby further improving the cleaning efficiency of the sample processor.

The sampling pipeline may be used to supply both the sample for processing and the sheath liquid for cleaning, thereby simplifying the structure of the pipeline system and thus the sample processor.

The above and other objects, features and advantages of the present disclosure will be more fully understood from the detailed description given below and the accompanying drawings, which are given by way of illustration only and therefore not considered to limit the present application.

### BRIEF DESCRIPTION OF THE DRAWINGS

The features and advantages of one or more embodiments of the present disclosure will become more readily understood from the following description with reference to the accompanying drawings. In the accompanying drawings:

FIG. 1A and FIG. 1B are schematic views of a peristaltic pump pipeline system according to an embodiment of the present disclosure;

FIG. 2 is a schematic view of a peristaltic pump pipeline system according to another embodiment of the present disclosure;

FIG. 3 is a schematic view of a peristaltic pump pipeline system according to yet another embodiment of the present disclosure;

FIG. 4 is a schematic view of a peristaltic pump pipeline system according to yet further embodiment of the present disclosure;

FIG. 5A is a flowchart of a method for cleaning a sampling pipeline of a sample processor according to an embodiment of the present disclosure;

FIG. 5B is a flowchart of another method for cleaning a sampling pipeline of a sample processor according to another embodiment of the present disclosure; and

FIG. 6 is a schematic view of a piston pump pipeline system according to another embodiment of the present disclosure.

### DETAILED DESCRIPTION OF EMBODIMENTS

Hereinafter, the present disclosure will be described in detail through exemplary embodiments with reference to the accompanying drawings. In several accompanying drawings, similar reference numerals refer to similar components and assemblies. The following detailed description of the present disclosure is for purposes of illustration only and is in no way intended to limit the present disclosure, its application or usages. The embodiments described in this specification are not exhaustive and are merely some of many possible embodiments. Exemplary embodiments may be embodied in many different forms and should not be construed as limitation to the scope of the present application. In some exemplary embodiments, well-known processes, well-known device structures, and well-known technologies may not be described in detail.

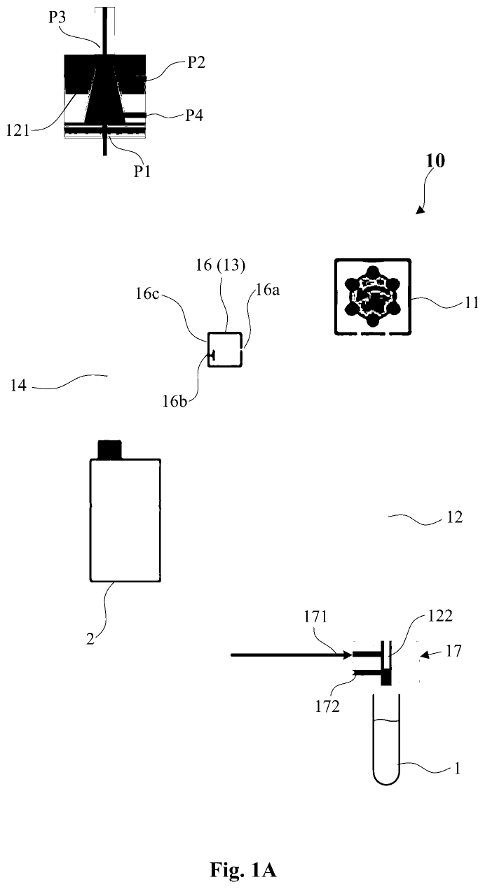

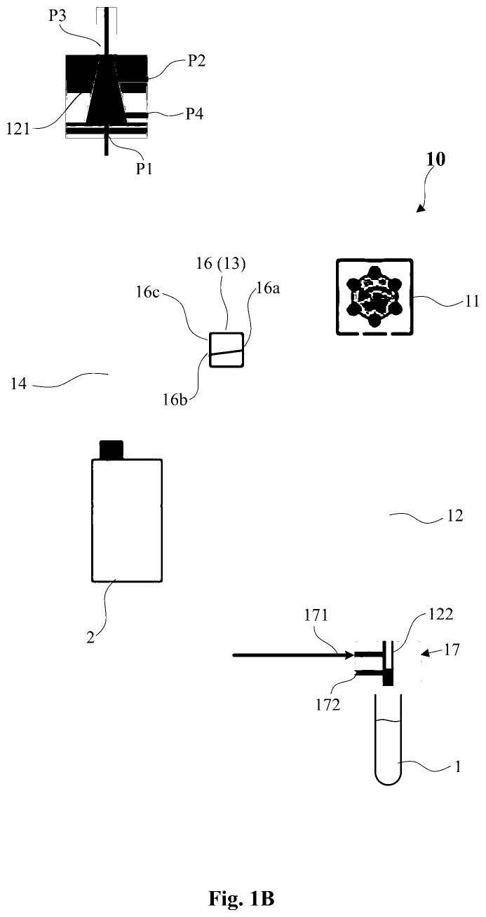

A pipeline system 10 with a peristaltic pump according to an embodiment of the present disclosure will be described below with reference to FIG. 1A and FIG. 1B. The peristaltic pump pipeline system 10 is used to supply a fluid (e.g., a sample, sheath liquid, cleaning liquid or the like) to a flow cell FC of a sample processor (not shown) or to discharge the fluid from the flow cell FC.

As shown in FIG. 1A and FIG. 1B, the peristaltic pump pipeline system 10 includes a peristaltic pump 11, a sampling pipeline 12, a switching device 13 and a cleaning liquid pipeline 14.

The sampling pipeline 12 connects a sample source 1 containing the sample to the flow cell FC. The sample source 1 may be, for example, a container, a bottle or a reagent kit that contains the sample. The sample contains small suspended particles to be detected or sorted in the flow cell FC, for example, biological particles such as extracellular vesicles or non-biological particles such as beads. The flow cell FC includes: a sample port P1 configured to receive the sampling pipeline 12; a sheath liquid port P2 connected to a sheath liquid pipeline so as to supply the sheath liquid; a detection port P3 configured to output a sample wrapped by the sheath liquid for detection; and a discharge port P4 for discharging waste liquid (for example, unused residual fluid or the cleaning fluid for cleaning the flow cell) from the flow cell FC.

One end of the sampling pipeline 12 connected to the flow cell FC has a flow cell opening 121, and the other end of the sampling pipeline 12 connected to the sample source 1 has a sample opening 122. A washing station 17 is provided at the sample opening 122 of the sampling pipeline 12. The washing station 17 has a sheath liquid port 171 for supplying the sheath liquid and a discharge port 172 for discharging waste liquid. When the sampling pipeline 12 is moved so that the sample opening 122 is in the sample source 1, the sample stored in the sample source 1 may be drawn into the flow cell FC via the sampling pipeline 12. When the sampling pipeline 12 is moved so that the sample opening 122 is in the washing station 17, the sheath liquid supplied via the sheath liquid port 171 may be drawn into the sampling pipeline 12, alternatively the fluid in the sampling pipeline 12 may be discharged via the discharge port 172.

The peristaltic pump 11 is provided in the sampling pipeline 12, and is used to pump the sample from the sample source 1 to the flow cell FC via the sampling pipeline 12, so as to process (for example, detect or sort) the particles of the sample in the flow cell FC.

The cleaning liquid pipeline 14 connects a cleaning liquid source 2 to the peristaltic pump 11. The cleaning liquid source 2 is, for example, a container, a tank, or a barrel that contains the cleaning liquid. The “cleaning liquid” mentioned herein refers to the solution or solvent used to wash the sample, other than the sheath liquid. The cleaning liquid may be selected or changed according to the sample.

The switching device 13 is configured to control interruption or communication of the cleaning liquid pipeline 14 and interruption or communication of the sampling pipeline 12. The supply of different fluids is controlled through controlling the interruption or communication of the cleaning liquid pipeline 14 and the interruption or communication of the sampling pipeline 12. When the sampling pipeline 12 is communicated and the cleaning liquid pipeline 14 is interrupted, fluid (for example, the sample stored in the sample source or the fluid stored in the flow cell) is allowed to flow between the sample source 1 and the flow cell FC via the sampling pipeline 12, while the cleaning liquid is prevented from flowing through the cleaning liquid pipeline 14. When the cleaning liquid pipeline 14 is communicated and the sampling pipeline 12 is interrupted, the cleaning liquid stored in the cleaning liquid source 2 is allowed to be supplied to the peristaltic pump 11, while the fluid is prevented from flowing from the sample source 1 to the flow cell FC or from the flow cell FC to the sample source 1. That is, the switching device 13 is used to control one of the cleaning liquid pipeline 14 and the sampling pipeline 12 to be communicated, and control the other of the cleaning liquid pipeline 14 and the sampling pipeline 12 to be interrupted.

The switching device 13 may be a switching device that may be automatically controlled, for example, an electronically controlled switching device or an electromagnetically controlled switching device.

In the example shown in FIG. 1A and FIG. 1B, the switching device 13 is a three-way directional valve 16 provided between the peristaltic pump 11, the cleaning liquid source 2 and the flow cell FC. The directional valve 16 may be switched between a first position for allowing the communication between the sample source 1 and the flow cell FC and a second position for allowing the communication between the peristaltic pump 11 and the cleaning liquid source 2. The directional valve 16 has a first port 16a connected to the peristaltic pump 11, a second port 16b connected to the cleaning liquid source 2, and a third port 16c connected to the flow cell FC. The directional valve 16 may be switched between a first position where the first port 16a is communicated with the third port 16c (i.e., the sample source 1 is communicated with the flow cell FC as shown in FIG. 1A) and a second position where the first port 16a is communicated with the second port 16b (i.e., the peristaltic pump 11 is communicated with the cleaning liquid source 2).

When the sample source 1 is communicated with the flow cell FC as shown in FIG. 1A, the peristaltic pump 11 may be rotated in one direction (for example, counterclockwise direction), thereby pumping the sample stored in the sample source 1 to the flow cell FC for detection or sorting of the sample, alternatively the sheath liquid stored in the washing station 17 at the sample source 1 is supplied to the flow cell FC for cleaning the sampling pipeline 12 with the sheath liquid.

When the sample source 1 is communicated with the flow cell FC as shown in FIG. 1A, the peristaltic pump 11 may be rotated in an opposite direction (for example, clockwise direction), thereby causing the fluid accumulated in the flow cell FC to flow to the sample source 1. For example, by rotating the peristaltic pump 11 clockwise, the sheath liquid in the flow cell FC flows through the sampling pipeline 12 and reaches a washing station 17 positioned at the sample source 1, thereby cleaning the peristaltic pump 11 and the sampling pipeline 12 with the sheath liquid. The waste liquid generated from cleaning with the sheath liquid may flow into the washing station 17, and then may be discharged via the discharge port 172 under the action of a waste liquid pump (not shown in FIG. 1A).

When the peristaltic pump 11 is communicated with the cleaning liquid source 2 as shown in FIG. 1B, the peristaltic pump 11 may be rotated clockwise so as to supply the cleaning liquid stored in the cleaning liquid source 2 to the peristaltic pump 11 and allow the cleaning liquid to flow through the peristaltic pump 11, thereby cleaning the peristaltic pump 11 with the cleaning liquid. The waste liquid generated from cleaning the peristaltic pump 11 may flow into the washing station 17 via the section of the sampling pipeline 12 extending from the peristaltic pump 11 to the sample source 1, and then may be discharged via the discharge port 172 under the action of a waste liquid pump (not shown in FIG. 1B). In addition, the peristaltic pump 11 may be rotated counterclockwise so as to draw the sheath liquid stored in the washing station 17 into the sampling pipeline 12 in order to clean the section of the sampling pipeline 12 extending from the sample opening 122 to the directional valve 16 with the sheath liquid.

According to the peristaltic pump pipeline system 10, by providing the cleaning liquid pipeline 14 and controlling position of the switching device 13, the interruption or communication of the cleaning liquid pipeline 14 can be easily controlled. Therefore, it is not necessary to manually replace the sample source with a cleaning liquid source containing cleaning liquid, thereby reducing time required for the replacement, improving the efficiency of the sample processor, and avoiding wrong operation caused by manual replacement.

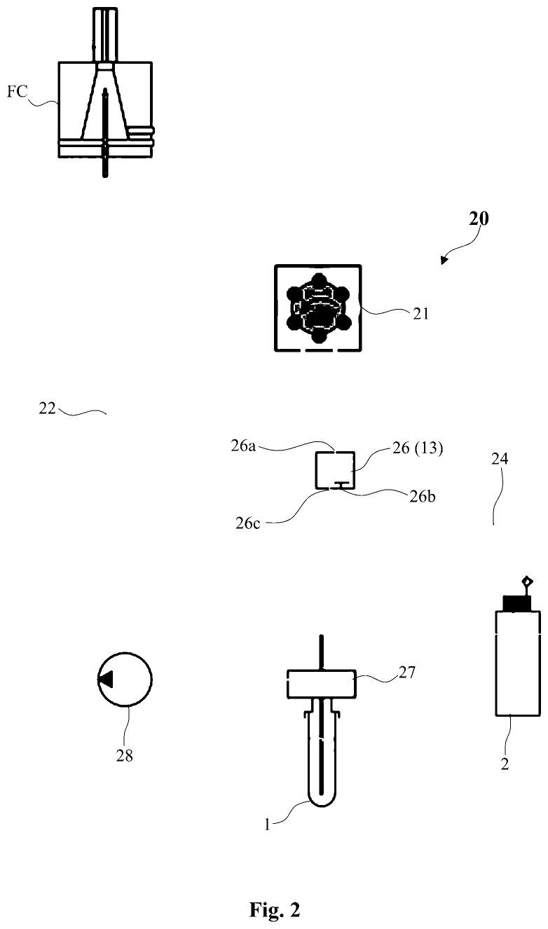

Next, a peristaltic pump pipeline system 20 according to another embodiment of the present disclosure will be described with reference to FIG. 2. As shown in FIG. 2, the peristaltic pump pipeline system 20 includes a peristaltic pump 21, a sampling pipeline 22, a cleaning liquid pipeline 24 and a switching device 13. The difference between the peristaltic pump pipeline system 20 shown in FIG. 2 and the peristaltic pump pipeline system 10 shown in FIG. 1 lies in position of the switching device 13.

As shown in FIG. 2, the switching device 13 is a three-way directional valve 26, which is provided between the peristaltic pump 21, the cleaning liquid source 2 and the sample source 1. The three-way directional valve 26 has a first port 26a connected to the peristaltic pump 21, a second port 26b connected to the cleaning liquid source 2 and a third port 26c connected to the sample source 1. The three-way directional valve 26 may be switched between a first position where the first port 26a is communicated with the third port 26c (i.e., the sample source 1 is communicated with the flow cell FC, as shown in FIG. 2) and a second position where the first port 26a is communicated with the second port 26b (i.e., the peristaltic pump 21 is communicated with the cleaning liquid source 2).

When the sample source 1 is communicated with the flow cell FC as shown in FIG. 2, the peristaltic pump 21 may be rotated in a counterclockwise direction, thereby pumping the sample stored in the sample source 1 to the flow cell FC for detection or sorting of the sample, alternatively the sheath liquid stored in the washing station 27 is drawn into the sampling pipeline 22 so as to clean the sampling pipeline 22 with the sheath liquid.

When the sample source 1 is communicated with the flow cell FC as shown in FIG. 2, the peristaltic pump 21 may be rotated in a clockwise direction, thereby causing the sheath liquid in the flow cell FC to flow to the sample source 1, so as to clean the peristaltic pump 21 and the sampling pipeline 22 with the sheath liquid. The waste liquid generated from cleaning with the sheath liquid may flow to a washing station 27 located at the sample source 1, and then may be discharged by the waste liquid pump 28.

When the peristaltic pump 21 is communicated with the cleaning liquid source 2, the peristaltic pump 21 may be rotated counterclockwise so as to supply the cleaning liquid stored in the cleaning liquid source 2 to the peristaltic pump 21 and allow the cleaning liquid to flow through the peristaltic pump 21, thereby cleaning the peristaltic pump 21 with the cleaning liquid. The waste liquid generated from cleaning the peristaltic pump 21 may flow into the flow cell FC via a section of the sampling pipeline 22 extending from the flow cell FC to the peristaltic pump 21, and then be discharged through the discharge port P4 that is connected to the flow cell FC.

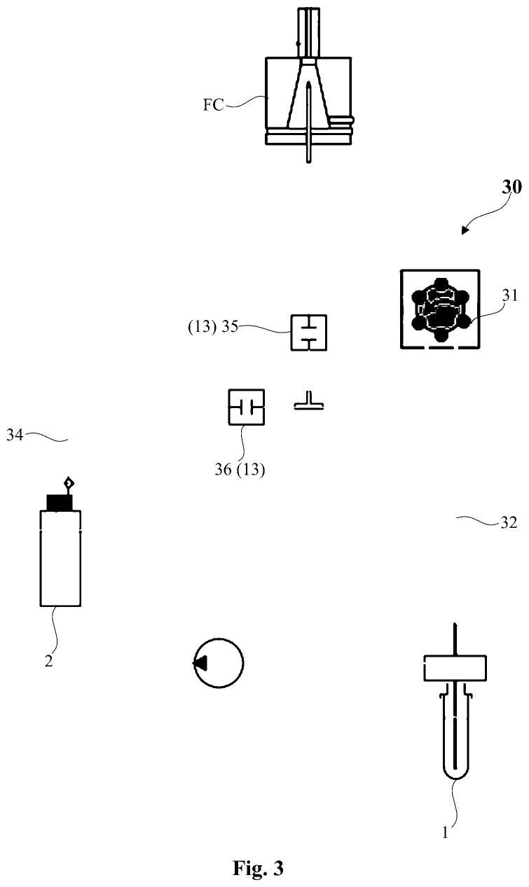

Next, a peristaltic pump pipeline system 30 according to further embodiment of the present disclosure will be described with reference to FIG. 3. As shown in FIG. 3, the peristaltic pump pipeline system 30 includes a peristaltic pump 31, a sampling pipeline 32, a cleaning liquid pipeline 34 and a switching device 13. The difference between the peristaltic pump pipeline system 30 shown in FIG. 3 and the peristaltic pump pipeline system 10 shown in FIG. 1 lies in construction of the switching device 13.

As shown in FIG. 3, the switching device 13 includes a first on-off valve 35 provided in the sampling pipeline 32 and a second on-off valve 36 provided in the cleaning liquid pipeline 34.

When the first on-off valve 35 is closed and the sample source 1 is thereby brought in communication with the flow cell FC, the peristaltic pump 31 may be rotated in a counterclockwise direction, thereby pumping the sample stored in the sample source 1 into the flow cell FC for detection or sorting of the sample, alternatively the sheath liquid stored in the washing station is drawn into the sampling pipeline 32 so as to clean the sampling pipeline 32 with the sheath liquid.

When the first on-off valve 35 is closed and the sample source 1 is thereby brought in communication with the flow cell FC, the peristaltic pump 31 may be rotated in a clockwise direction, thereby causing the sheath liquid stored in the flow cell FC to flow to the sample source 1, so as to clean the peristaltic pump 31 and the sampling pipeline 32 with the sheath liquid.

When the second on-off valve 36 is closed and the peristaltic pump 31 is thereby brought in communication with the cleaning liquid source 2, the peristaltic pump 31 may be rotated in a clockwise direction, so that the cleaning liquid stored in the cleaning liquid source 2 is supplied to the peristaltic pump 31 and flows through the peristaltic pump 31, thereby cleaning the peristaltic pump 31 with the cleaning liquid. Similarly, when the second on-off valve 36 is closed and the peristaltic pump 31 is thereby brought in communication with the cleaning liquid source 2, the peristaltic pump 31 may be rotated in a counterclockwise direction, so that the sheath liquid stored in the washing station is drawn into the sampling pipeline 32 so as to clean the sampling pipeline 32 with the sheath liquid.

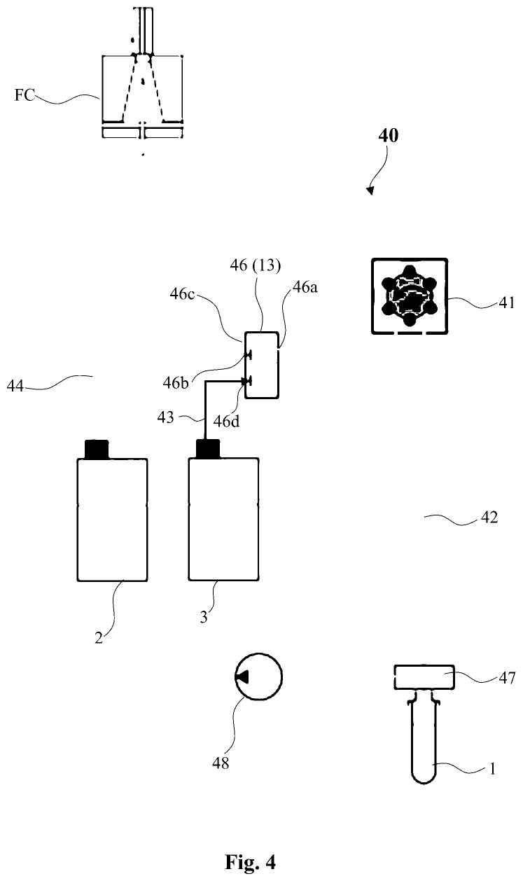

Next, a peristaltic pump pipeline system 40 according to another embodiment of the present disclosure will be described with reference to FIG. 4. In the peristaltic pump pipeline system shown in FIGS. 1 to 3, the sampling pipeline may also be used as the sheath pipeline, for example, when the peristaltic pump rotates in a direction opposite to that when sampling. In the peristaltic pump pipeline system 40 shown in FIG. 4, a sheath pipeline 43 is provided independently of the sampling pipeline 42 to clean the peristaltic pump 41 with the sheath liquid, and the switching device 13 is further configured to control interruption or communication of the sheath pipeline 43.

As shown in FIG. 4, the sheath pipeline 43 connects a sheath liquid source 3 containing the sheath liquid to the peristaltic pump 41. The switching device 13 is a four-way directional valve 46. The four-way directional valve 46 has a first port 46a connected to the peristaltic pump 41, a second port 46b connected to the cleaning liquid source 2, a third port 46c connected to the flow cell FC and a fourth port 46d connected to the sheath liquid source 3. The four-way directional valve 46 is switched between a first position where the first port 46a is communicated with the third port 46c, a second position where the first port 46a is communicated with the second port 46b, and a third position where the first port 46a is communicated with the fourth port 46d.

When the four-way directional valve 46 is in the first position as shown in FIG. 4, the first port 46a is communicated with the third port 46c, and the peristaltic pump 41 is rotated in a counterclockwise direction to pump the sample stored in the sample source 1 to the flow cell FC for detection or sorting of the sample.

When the four-way directional valve 46 is in the second position, the first port 46a is communicated with the second port 46b, that is, the cleaning liquid source 2 is communicated with the peristaltic pump 41, so that the cleaning liquid in the cleaning liquid source 2 may be supplied to the peristaltic pump 41 via the cleaning liquid pipeline 44, so as to clean the peristaltic pump 41 with the cleaning liquid. This process is the same as the example shown in FIG. 1A, and thus is omitted herein.

When the four-way directional valve 46 is in the third position, the first port 46a is communicated with the fourth port 46d, that is, the sheath liquid source 3 is communicated with the peristaltic pump 41. When the peristaltic pump 41 rotates clockwise, the sheath liquid in the sheath liquid source 3 is drawn into the peristaltic pump 41 and flows through the peristaltic pump 41. In this way, the peristaltic pump 41 is cleaned with the sheath liquid. The waste liquid generated from cleaning the peristaltic pump 41 may flow into a washing station 47 via the section of the sampling pipeline 42 running from the peristaltic pump 41 to the sample source 1, and then may be discharged by a waste liquid pump 48.

It should be understood that the peristaltic pump pipeline system according to the present disclosure should not be limited to the specific examples shown in the drawings, but may be varied as needed, as long as the functions described herein can be realized.

The present disclosure also relates to a sample processor including the peristaltic pump pipeline system described above. The peristaltic pump pipeline system transports the sample and the sheath liquid to the flow cell through fluidics components including the peristaltic pump, valves and the like, so that the sheath liquid surrounds the sample within the flow cell, and the particles contained in the sample can flow through the flow cell in a single straight line, so as to collect the signals of the particles one by one. When the particles pass through the detection area, they are irradiated by a light source (usually a laser light source) of an optical detection system. The irradiation can cause the particles in the sample to emit scattered light (for example, to generate a lateral scattered light signal or a forward scattered light signal). In some cases, the sample may include fluorescent particles that can emit fluorescent signals in response to irradiation. These signals are collected by the optical detection system. The collected signals of particles are processed and analyzed by a sample analysis system to obtain the information of the detected particles.

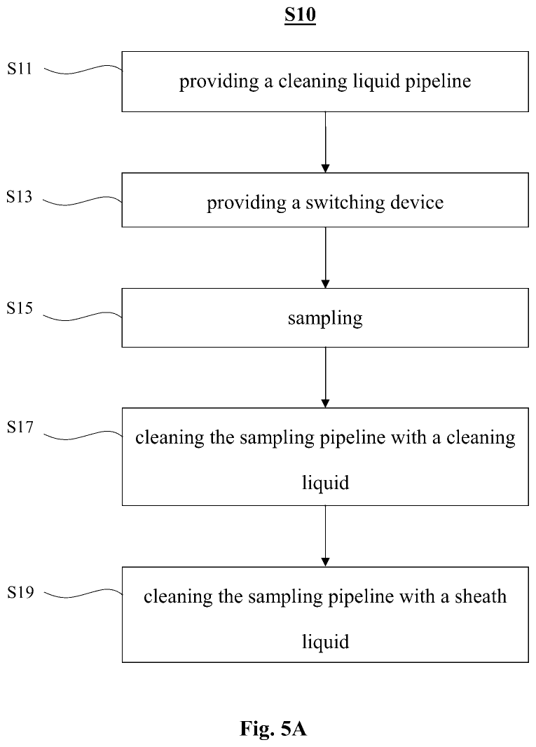

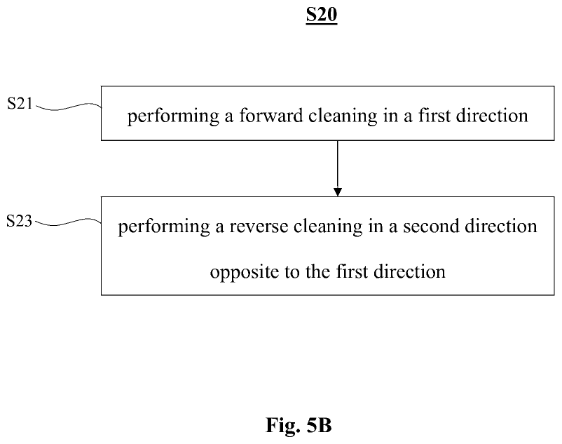

Next, a method S10 for cleaning a peristaltic pump of a sample processor according to an embodiment of the present disclosure will be described with reference to FIG. 5A. FIG. 5A is a flowchart of a method S10 for cleaning a peristaltic pump of a sample processor according to an embodiment of the present disclosure.

As shown in FIG. 5A, the method S10 includes providing a cleaning liquid pipeline that connects a cleaning liquid source to the peristaltic pump (step S11) and providing a switching device in the cleaning liquid pipeline (step S13). By providing the cleaning liquid pipeline for supplying the cleaning liquid to the peristaltic pump, it is not necessary to use the sampling pipeline to provide the cleaning liquid, so it is not necessary to replace the sample source with the cleaning liquid source. By providing the switching device, the cleaning step with the cleaning liquid and the supplying step of other fluids (for example, the sample or sheath liquid) can be easily switched, thereby improving the efficiency. Preferably, the switching device may be automatically controlled. In this way, fluid supplying and switching may be automatically performed, which can significantly shorten the operation time of the sample processor and greatly improve the working efficiency.

After the peristaltic pump pipeline system is built up, the switching device may be used to control the sampling pipeline to be communicated and the cleaning liquid pipeline to be interrupted for sampling (step S15). Under the action of the peristaltic pump, the sample is supplied from the sample source to a flow cell via the sampling pipeline, so that particles in the sample can be processed (for example, detected or sorted).

After the sample is processed, it is necessary to clean various pipelines and pumps. Particularly, in step S17, the switching device controls the sampling pipeline to be interrupted and the cleaning liquid pipeline to be communicated for cleaning the peristaltic pump with the cleaning liquid. The cleaning liquid may be selected based on the particles detected in the sample to effectively clean the peristaltic pump and the fluid pipeline.

In addition, the method S10 may further include cleaning the peristaltic pump with a sheath liquid (step S19). The sheath liquid may be provided through the sampling pipeline by means of the reverse rotation of the peristaltic pump (as shown in FIGS. 1A to 3), or be provided through an additional sheath pipeline (as shown in FIG. 4).

Steps S17 and S19 may be alternately switched and performed for a predetermined number of times to meet the cleaning requirements. The predetermined number of times and/or the duration of each cleaning step may be changed according to the cleaning requirements.

FIG. 5B is a flowchart of a method S20 for cleaning a sampling pipeline of a sample processor according to another embodiment of the present disclosure.

As shown in FIG. 5B, the method S20 includes cleaning the sampling pipeline in the first direction, see step S21. In step S21, the sampling pipeline may be cleaned with sheath liquid or cleaning liquid different from the sheath liquid and provided via the cleaning liquid pipeline, which may be called forward rinsing. In the case of having both sheath liquid pipeline and cleaning liquid pipeline, the sheath liquid or other cleaning liquid may be selectively used to perform a forward cleaning of the sampling pipeline.

In step S23, sheath liquid or other cleaning liquid may be used to rinse the sampling pipeline in a second direction opposite to the first direction, which can be called reverse rinsing. Similarly, in the case of having both the sheath liquid pipeline and the cleaning liquid pipeline, sheath liquid or other cleaning liquid may be selectively used to perform a reverse cleaning of the sampling pipeline.

Step S21 and step S23 may be alternately performed. Step S21 and step S23 may be alternately performed for a predetermined number of times. The predetermined number of times may be determined based on the sample to be detected, the type of cleaning liquid, and the like.

The inventor of the present application has found that the sampling pipeline may be cleaned by alternating forward and reverse cleaning, so it is possible to significantly shorten the cleaning time, improve the cleaning efficiency, and also significantly improve the cleaning effect. The inventor has tested the alternating forward and reverse cleaning method, and the cleaning time may be shortened to half or less, that is, the cleaning efficiency may be improved by one time or more, compared to the existing cleaning method. For viruses, the residual rate of virus was reduced to below 1.0% after 15 minutes of cleaning. For the 3 micron bead, the residual rate of the bead was reduced to below 0.1% after 10 seconds of cleaning. Since the cleaning time is significantly shortened, the amount of sheath liquid or cleaning liquid required is also significantly reduced, and the flux of the sample processor is greatly increased.

It should be understood that the method for cleaning the sampling pipeline of the sample processor according to the present disclosure should not be limited to the specific examples shown in the drawings or described herein, but may be changed as needed. The steps of the method are not necessarily performed in the order described, but may be adjusted as needed.

In addition to the various examples with the peristaltic pump shown in FIGS. 1A to 4, a pipeline system or a sample processor with other pumps is also suitable for implementing the above method and may achieve similar or superior technical effects.

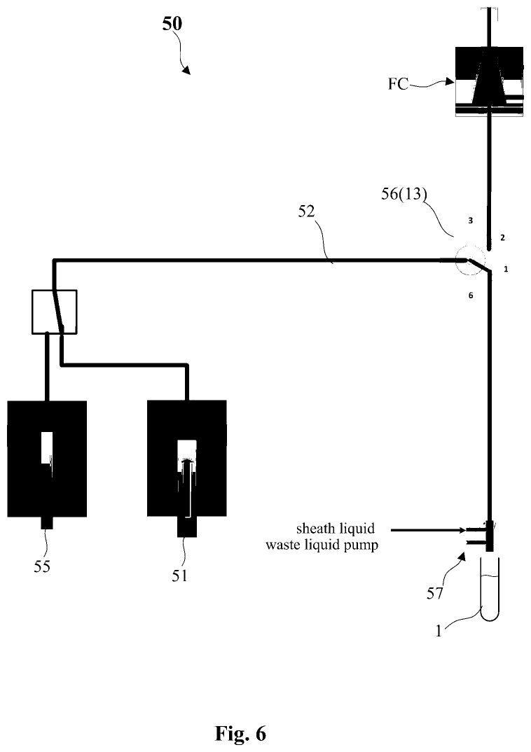

A pipeline system 50 with a piston pump and the process of performing the method shown in FIG. 5B will be described with reference to FIG. 6.

As shown in FIG. 6, the pipeline system 50 includes piston pumps 51 and 55, a sampling pipeline 52 and a switching device 13. The piston pump 51 is configured to clean the sampling pipeline 52, and the piston pump 55 is configured for sampling. It should be understood that it should not be limited to the specific examples shown in the accompanying drawings, but may be changed. For example, only one piston pump may be used to realize the functions of both the piston pumps 51 and 55.

In the example shown in FIG. 6, the switching device 13 is a rotary valve 56. Whether the piston pump is communicated with the sample source 1 or the flow cell FC is switched by the rotation of the rotary valve 56. However, it should be understood that the switching device should not be limited to the specific example shown in the accompanying drawings, but may be changed as long as it is capable of realizing the functions herein.

The forward rinsing in step S21 and the reverse rinsing in step 23 shown in FIG. 5B may be alternately preformed through the reciprocating motion of a piston of the piston pump 51. When the piston of the piston pump 51 is moved downwardly, the sheath liquid stored in the washing station 57 or the flow cell FC is drawn into the sampling pipeline 52 to perform the forward rinsing of the sampling line. When the piston of the piston pump 51 is moved upwardly, the sheath liquid stored in the sampling pipeline 52 is pushed into the washing station 57 or the flow cell FC for discharge. As described above, the piston pump 51 may be selectively communicated with the washing station 57 or the flow cell FC through the switching device 13 (rotary valve 56), so as to selectively draw or discharge fluid from the washing station 57 or the flow cell FC.

The piston pump pipeline system shown in FIG. 6 may further improve the cleaning efficiency compared with the peristaltic pump pipeline system shown in FIGS. 1A to 4. The speed of repeated cleaning of the peristaltic pump is 1.5 to 1.8 ml/min (milliliter/minute). The speed of the piston pump is much higher. For a range of 100 ul (microliter), the speed of repeated cleaning of piston pump may reach 6.0 ml/min. For a range of 500 ul, the speed of repeated cleaning of piston pump may reach 30.0 ml/min. And for a range of 1000 ul, the speed of repeated cleaning of piston pump may reach 60.0 ml min.

Because the speed of the piston pump is much faster than that of the peristaltic pump, its cleaning efficiency and cleaning effect are also significantly improved.

Although the present disclosure has been described with reference to exemplary embodiments, it should be understood that the present disclosure is not limited to the specific embodiments described and illustrated herein. Without departing from the scope defined by the appended claims, those skilled in the art may make various changes to the exemplary embodiments. Provided that there is no contradiction, the features in various embodiments may be combined with each other. Alternatively, a certain feature in the embodiment may also be omitted.

1. A method for cleaning a sampling pipeline of a sample processor, wherein the sampling pipeline communicates a flow cell to a sample source of the sample processor,
the method comprises:
a forward rinsing step of rinsing the sampling pipeline in a first direction by using a sheath liquid or a cleaning liquid different from the sheath liquid and provided via a cleaning liquid pipeline; and/or
a reverse rinsing step of rinsing the sampling pipeline in a second direction opposite to the first direction by using the sheath liquid or the cleaning liquid.

2. The method according to claim 1, wherein the method comprises:
performing the forward rinsing step and the reverse rinsing step alternately for a predetermined number of times.

3. The method according to claim 1 or 2, wherein the method comprises:
communicating the sheath liquid to a flow-cell opening and/or a sample opening of the sampling pipeline.

4. The method according to claim 3, wherein a washing station is provided at the sample opening of the sampling pipeline, and the washing station has a sheath liquid port for supplying the sheath fluid and a discharge port for discharging waste liquid; and/or
the flow cell has a sheath liquid port for supplying the sheath liquid and a discharge port for discharging waste liquid.

5. The method according to claim 1 or 2, wherein the method comprises:
selectively using the sheath fluid or the cleaning liquid to clean the sampling pipeline by means of a switching device provided in the cleaning liquid pipeline and the sampling pipeline.

6. The method according to claim 5, wherein the switching device is automatically controlled.

7. The method according to claim 1 or 2, wherein the method comprises:
providing a peristaltic pump, and performing the forward rinsing step or the reverse rinsing step by controlling rotation direction of a roller of the peristaltic pump.

8. The method according to claim 1 or 2, wherein the method comprises:
providing a piston pump, and alternately performing the forward rinsing step and the reverse rinsing step through reciprocating motion of a piston of the piston pump.

9. A pipeline system for implementing the method according to claim 1.

10. The pipeline system according to claim 9, wherein the pipeline system comprises a piston pump and a switching device provided in the sampling pipeline,
the switching device is configured to selectively communicate the piston pump to the sample source or the flow cell,
the piston pump is configured to alternately perform the forward rinsing step and the reverse rinsing step through reciprocating motion of a piston of the piston pump.

11. The pipeline system according to claim 10, wherein the switching device is a rotary valve.

12. The pipeline system according to claim 9, wherein the pipeline system comprises a peristaltic pump that is configured to perform the forward rinsing step or the reverse rinsing step by controlling rotation direction of a roller of the peristaltic pump.

13. The pipeline system according to claim 12, wherein the pipeline system comprises a switching device provided in the sampling pipeline and a cleaning liquid pipeline for supplying a cleaning liquid different from the sheath liquid,
the switching device is configured to selectively supply a sample, sheath liquid or cleaning liquid.

14. The pipeline system according to claim 13, wherein the switching device is a directional valve or an on-off valve.

15. The pipeline system according to claim 10 or 13, wherein the switching device is a switching device which can be automatically controlled.

16. The pipeline system according to any one of claims 9 to 14, wherein a washing station is provided at a sample opening of the sampling pipeline, and the washing station has a sheath liquid port for supplying the sheath fluid and a discharge port for discharging waste liquid; and/or
the flow cell has a sheath liquid port for supplying the sheath liquid and a discharge port for discharging waste liquid.

17. A sample processor comprising the pipeline system according to any one of claims 9 to 16.

18. A peristaltic pump pipeline system for a sample processor, comprising:
a peristaltic pump;
a sampling pipeline via which the peristaltic pump can pump a sample in a sample source to a flow cell of the sample processor;
a cleaning liquid pipeline connecting a cleaning liquid source to the peristaltic pump; and
a switching device configured to control interruption or communication of the cleaning liquid pipeline and interruption or communication of the sampling pipeline.

19. The peristaltic pump pipeline system according to claim 18, wherein the switching device is a directional valve, and the directional valve can be switched between a first position for allowing communication between the sample source and the flow cell, and a second position for allowing communication between the peristaltic pump and the cleaning liquid source.

20. The peristaltic pump pipeline system according to claim 19, wherein the directional valve is a three-way directional valve,
the three-way directional valve has a first port connected to the peristaltic pump, a second port connected to the cleaning liquid source and a third port connected to the flow cell or the sample source, and
the three-way directional valve can be switched between the first position where the first port and the third port are communicated, and the second position where the first port and the second port are communicated.

21. The peristaltic pump pipeline system according to claim 18, wherein the switching device comprises a first on-off valve provided in the sampling pipeline and a second on-off valve provided in the cleaning liquid pipeline.

22. The peristaltic pump pipeline system according to any one of claims 18 to 21, wherein the switching device is a switching device that can be automatically controlled.

23. The peristaltic pump pipeline system according to claim 18 or 19, further comprising:
a sheath pipeline connecting a sheath source to the peristaltic pump,
wherein the switching device is further configured to control interruption and communication of the sheath pipeline.

24. The peristaltic pump pipeline system according to claim 23, wherein the switching device is a four-way directional valve,
the four-way directional valve has a first port connected to the peristaltic pump, a second port connected to the cleaning liquid source, a third port connected to the flow cell or the sample source and a fourth port connected to the sheath source, and
the four-way directional valve can be switched between a first position where the first port and the third port are communicated, a second position where the first port and the second port are communicated, and a third position where the first port and the fourth port are communicated.

25. A method of cleaning a peristaltic pump of a sample processor, wherein the peristaltic pump is configured to pump a sample in a sample source to a flow cell of the sample processor via a sampling pipeline,
the method comprises the steps of:
providing a cleaning liquid pipeline that connects a cleaning liquid source to the peristaltic pump;
providing a switching device in the cleaning liquid pipeline;
controlling, by the switching device, the sampling pipeline to be communicated and the cleaning liquid pipeline to be interrupted for sampling; and
after the sample is processed, controlling, by the switching device, the sampling pipeline to be interrupted and the cleaning liquid pipeline to be communicated for cleaning the peristaltic pump with a cleaning liquid.

26. The method according to claim 25, further comprising:
cleaning the peristaltic pump with a sheath liquid.

27. The method according to claim 26, wherein the step of cleaning with the cleaning liquid and the step of cleaning with the sheath liquid are alternately switched and performed a predetermined number of times by the switching device.

28. The method according to claim 26 or 27, wherein the sheath liquid is supplied from the flow cell to the peristaltic pump via the sampling pipeline.

29. The method according to claim 28, wherein the peristaltic pump is rotated in a first direction for sampling; and
the peristaltic pump is rotated in a second direction opposite to the first direction for cleaning the peristaltic pump with the sheath liquid.

30. The method according to claim 29, wherein the switching device is a three-way directional valve, having a first port connected to the peristaltic pump, a second port connected to the cleaning liquid source, and a third port connected to the flow cell or the sample source, and
the three-way directional valve can be switched between a first position where the first port and the second port are communicated, and a second position where the first port and the third port are communicated.

31. The method according to claim 26 or 27, wherein the sheath liquid is supplied to the peristaltic pump via a sheath pipeline which connects the sheath source to the peristaltic pump.

32. The method according to claim 31, wherein the switching device is a four-way directional valve, having a first port connected to the peristaltic pump, a second port connected to the cleaning liquid source, a third port connected to the flow cell or the sample source, and a fourth port connected to the sheath source, and
the four-way directional valve can be switched between a first position where the first port and the second port are communicated, a second position where the first port and the third port are communicated, and a third position where the first port and the fourth port are communicated.

33. The method according to any one of claims 25 to 27, wherein the switching device comprises a first on-off valve provided in the sampling pipeline, and a second on-off valve provided in the cleaning liquid pipeline.

34. The method according to any one of claims 25 to 27, wherein the switching device is automatically controlled.

35. A sample processor comprising the peristaltic pump pipeline system according to any one of claims 18 to 24.
